(19) United States
(12) Patent Application Publication
(10) Pub. No.: US 2013/0014721 A1
(43) Pub. Date: Jan. 17, 2013

(54) CYLINDER HEAD FOR INTERNAL COMBUSTION ENGINE

(71) Applicant: John Trease, Melbourne (AU)

(72) Inventor: John Trease, Melbourne (AU)

(21) Appl. No.: 13/181,958

(22) Filed: Jul. 13, 2011

(51) Int. Cl. F02F 1/42

(52) U.S. Cl. 123/193.5

(57) ABSTRACT

A cylinder head for an internal combustion engine is shaped and dimensioned to sit above a cylinder on top of a cylinder block so as to define a combustion chamber. The cylinder head includes a cylinder head body having a lower cavity defining a portion of a combustion chamber when the cylinder head is secured to a cylinder block. The cylinder head body also includes an intake port and an exhaust port in fluid communication with the lower cavity, wherein the exhaust port has a generally L-shaped configuration as its extends from an inlet end of the exhaust port to an outlet end of the exhaust port, and the intake port has a generally L-shaped configuration as its extends from an inlet end of the intake port to an outlet end of intake port. The intake port includes an inlet leg, an outlet leg and an inlet elbow therebetween, and as the intake port approaches the inlet elbow, a passageway of the exhaust port bifurcates into adjacent substantially oval passageways.

### BACKGROUND OF THE INVENTION

1. Field of the Invention

This invention relates to internal combustion engines of the type comprising twin cylinders arranged in a V-shaped arrangement in a plane normal to the crankshaft. More particularly, the invention relates to the cylinder heads included in such engines, whereby the cylinder head allows for a very efficient gas flow from intake to exhaust.

2. Description of the Related Art

A common type of motorcycle engine is the so called “V-twin” engine in which the two cylinders are arranged in a “V” with the cylinders lying on a plane which is transverse to the crankshaft and normal thereto. The axes of the cylinders meet at the axis of the crankshaft. Such engines also include a camshaft which is typically in the crankcase where it is driven by a pinion gear of the crankshaft. The camshaft, via pushrods and rocker arms, actuates valves which control the influx of air/fuel mixture from the carburetor and the efflux of combusted mixture. V-twin engines are also known to have twin camshafts. Such engines usually have superior performance over an otherwise identical engine because of the improved pushrod geometry which gives better operation of the valves.

### SUMMARY OF THE INVENTION

The object of the invention is to provide smooth and efficient gas flow for an internal combustion engine of the “V-twin” configuration. It is known by those of ordinary skill in the art of engine design that smooth and efficient gas flow from intake to exhaustion is an extremely critical factor of the engine's power output, fuel consumption and overall efficiency.

It is an object of the present invention to provide a cylinder head for an internal combustion engine, the cylinder head being shaped and dimensioned to sit above a cylinder on top of a cylinder block so as to define a combustion chamber. The cylinder head includes a cylinder head body having a lower cavity defining a portion of a combustion chamber when the cylinder head is secured to a cylinder block. The cylinder head body also includes an intake port and an exhaust port in fluid communication with the lower cavity, wherein the exhaust port has a generally L-shaped configuration as its extends from an inlet end of the exhaust port to an outlet end of the exhaust port, and the intake port has a generally L-shaped configuration as its extends from an inlet end of the intake port to an outlet end of intake port. The intake port includes an inlet leg, an outlet leg and an inlet elbow therebetween, and as the intake port approaches the inlet elbow, a passageway of the exhaust port bifurcates into adjacent substantially oval passageways.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an isometric view of the cylinder head in accordance with the present invention.

FIG. 2 is a bottom plan view of the cylinder head.

FIG. 3 is an alternate isometric view of the cylinder head.

FIG. 4 is a right plan view of the cylinder head.

FIG. 5 is a front plan view of the cylinder head.

FIG. 6 is a left plan view of the cylinder head.

FIG. 7 is a rear plan view of the cylinder head.

FIGS. 8, 9, 10 and 11 are various exploded assembly drawings of the present cylinder head.

FIG. 12 is a cross-sectional view of the assembled cylinder head along the line A-A in FIG. 13.

FIG. 13 is a partial sectional view of the cylinder head.

FIG. 14 is a cross-sectional view of the cylinder head along the line B-B in FIG. 13.

FIG. 15 is a partially sectioned isometric view the assembled cylinder.

FIG. 16 is a top plan view of the assembled cylinder head.

FIG. 17 is a partially sectioned isometric view of the cylinder head.

FIG. 18 is a cross-sectional view of the cylinder head along the line AW-AW in FIG. 20.

FIG. 19 is a cross-sectional view along the line AV-AV in FIG. 20.

FIG. 20 is a front plan view of the cylinder head.

FIG. 21 is a cross-sectional view of the cylinder head along the line AU-AU in FIG. 20.

FIG. 22 is a cross-sectional view along the line BH-BH.

FIG. 23 is a cross-sectional view along the line AY-AY in FIG. 20.

FIG. 24 is an auxiliary view along the line BC-BC in FIG. 25.

FIG. 25 is a cross-sectional view along the line BV-BV in FIG. 20.

FIG. 26 is a detailed view of the section BG shown in FIG. 24.

FIG. 27 is a detailed view of the section BF shown in FIG. 25.

FIG. 28 is a partially sectioned isometric view of the cylinder head.

FIG. 29 is a cross-sectional view along the line AF-AF in FIG. 30.

FIG. 30 is a front plan view of the cylinder head.

FIG. 30 is a representative view of the exhaust port.

FIG. 30A is a cross-sectional view along the line A-A in FIG. 30.

FIG. 31 is a representative view of the exhaust port.

FIG. 31 is a cross-sectional view along the line AB-AB in FIG. 31.

FIG. 32 is a representative view of the exhaust port.

FIG. 32A is a cross-sectional view along the line AC-AC in FIG. 32.

FIG. 33 is a representative view of the exhaust port.

FIG. 33A is a cross-sectional view along the line AD-AD in FIG. 33.

FIG. 34 is a representative view of the exhaust port.

FIG. 34 is a cross-sectional view along the line AE-AE in FIG. 34.

FIG. 35 is a representative view of the exhaust port.

FIG. 36 is a representative view of the intake port.

FIG. 36G is a cross-sectional view along the line AG-AG in FIG. 36.

FIG. 36H is a cross-sectional view along the line AH-AH in FIG. 36.

FIG. 36J is a cross-sectional view along the line AJ-AJ in FIG. 36.

FIG. 36K is a cross-sectional view along the line AK-AK in FIG. 36.

FIG. 36L is a cross-sectional view along the line AL-AL in FIG. 36.

FIG. 37 is a representative view of the exhaust port.

FIG. 37I is a cross-sectional view along the line AI-AI in FIG. 37.

FIG. 37M is a cross-sectional view along the line AM-AM in FIG. 37.

FIG. 37N is a cross-sectional view along the line AN-AN in FIG. 37.

FIG. 37O is a cross-sectional view along the line AO-AO in FIG. 37.

FIG. 37P is a cross-sectional view along the line AP-AP in FIG. 37.

FIG. 37Q is a cross-sectional view along the line AQ-AQ in FIG. 37.

FIG. 38 is a partially sectioned isometric view of the cylinder head.

FIG. 39 is a front plan view of the cylinder head.

FIG. 40 is a cross-sectional view of the cylinder head along the line AR-AR in FIG. 39.

FIG. 41 is a cross-sectional view along the line AS-AS in FIG. 39.

FIG. 42 is a cross section view along the line AT-AT in FIG. 39.

FIGS. 43-53 disclose various volume diagrams of the combustion chamber defined by the lower portion of the cylinder head.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

In accordance with the present invention, and with reference to the various figures, a cylinder head 10 for an internal combustion engine offering improved performance is disclosed. It is appreciated the cylinder head 10 is shaped and dimensioned to sit above a cylinder on top of a cylinder block. As such, the cylinder head 10 includes a cylinder head body 11 having opened upper and lower cavities 12, 13 with a side wall 14 defining the outer extremity of the cylinder head body 11. Fins 15 extend from the side wall 14 of the cylinder head body 11 enhancing heat exchange during use of the present cylinder 10. Fins 15a also extends from the rocker box 102 which is integrally formed with the cylinder head as described below in greater detail.

As is appreciated, the cylinder head 10 closes in the top of the cylinder, forming a combustion chamber. This joint between the cylinder head 10 and cylinder block is sealed by a head gasket. The cylinder head 10 also provides space for the ports 24, 26 that feed air and fuel to the cylinder, and that allows the exhaust to escape. The present cylinder head 10 also provides a mounting system for the incorporation of a fuel injector 22. In addition, and as will be appreciated based upon the following disclosure, upper cavity 12 provides space for the mounting of rocker arms 96, 98, while the lower cavity 13 ultimately defines the upper portion of the combustion chamber when the cylinder head 10 is secured to the cylinder block.

As discussed above, the present cylinder head 10 is designed for use in conjunction with a V-type internal combustion engine, in particular, a twin-V. As such, and as will be appreciate by the those skilled in the art, the motor (not shown) includes front and rear cylinders and corresponding front and rear cylinder heads 10. Each cylinder contains a reciprocating piston (not shown), and each of the cylinder heads 10 includes an intake valve assembly 28 and an exhaust valve assembly 30 for controlling the flow of intake and exhaust gases through respective combustion chambers. The cylinders (and the pistons therein) converge toward a crankshaft axis at a lower portion of the engine. The cylinder block includes cooling fins and is air cooled. The cylinder heads 10 also include air cooling fins 15 as discussed above.

More particular, the cylinder head 10 is coupled to an upper portion of the cylinder block with a gasket therebetween. A piston is slidably received in the cylinder provided in the cylinder block. The combustion chamber is, therefore, defined by the cylinder block, the cylinder head 10 (in particular, the lower cavity 13 of the cylinder head) and the piston (not shown).

The disclosed figures show only a representative cylinder head 10. It is appreciated the front and rear cylinder heads are substantially identical with the exception of being mirror-images thereof. The cylinder head 10 includes a base 32 forming the perimeter of the lower cavity 13. The base 32 is configured to face the corresponding cylinder of the engine and to be coupled to the upper edge of the cylinder block so as to define a combustion chamber. The cylinder head 10 further includes an intake side 34 defined by the intake port 24 and an exhaust side 36 defined by the exhaust port 26.

In particular, the intake side 34 includes the intake port 24 and the intake valve assembly 28 disposed within the intake port 24 and movable therein. The exhaust side 36 of the cylinder head 10 includes an exhaust port 26 and the exhaust valve assembly 30 disposed within the exhaust port 26 and movable therein. The intake valve assembly 28 selectively provides intake air/fuel from the intake port 24 into the combustion chamber, and the exhaust valve assembly 30 selectively releases combustion exhaust gases from the combustion chamber to the exhaust port 26. Heat from the combustion process tends to heat the cylinder head 10, especially in the areas around the combustion chamber and the exhaust port 26.

Provided in the cylinder head 10 is an intake valve bore 44 facing one side of a ceiling surface of the combustion chamber as defined by the lower cavity 13 of the cylinder head 10. The intake port 24 is connected commonly to the intake valve bore 44 and opens into one side surface, that is, the side wall 14, of the cylinder head 10. The cylinder head 10 also includes an exhaust valve bore 46 facing the other side of the ceiling surface of the combustion chamber as defined by the lower cavity 13 of the cylinder head 10. The exhaust port 26 is connected commonly to the exhaust valve bore 46 and opens into the other side surface, that is, the side wall 14 opposite that portion thereof from which the intake port 24 opens, of the cylinder head 10.

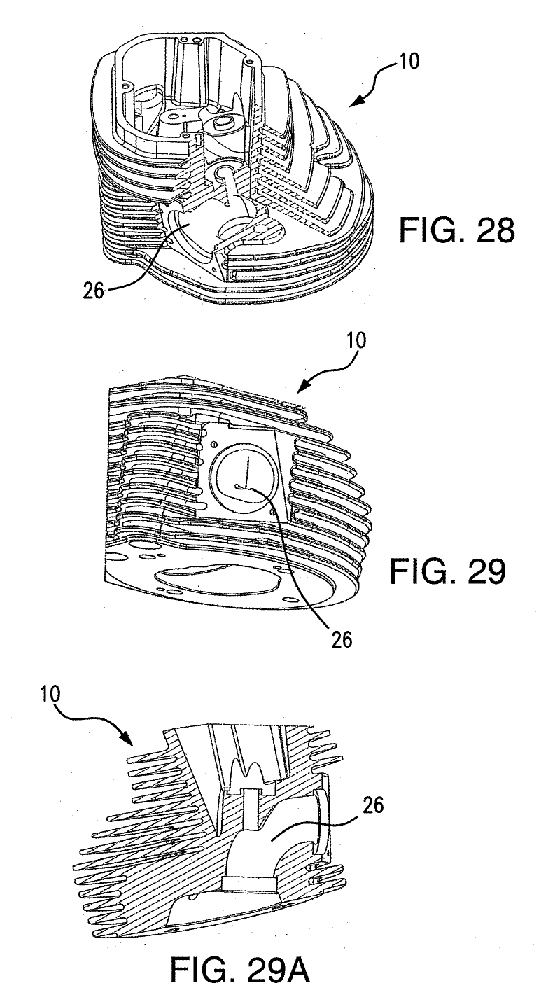

Improved airflow into an out of the combustion chamber is achieved in accordance with the present invention by the specific shape of both the exhaust port 26 and the intake port 24. First referring to the exhaust port 26, as shown with reference to FIGS. 28 to 35, the exhaust port 26 exhibits a generally L-shaped configuration as its extends from the inlet end 48 of the exhaust port 26 to the outlet end 50 of exhaust port 26. As such, the exhaust port 26 may be thought of as including an inlet leg 52, an outlet leg 54 and an exhaust elbow 56 therebetween. This L-shape results in a 90 degree turn, which it is appreciated generates flow issues that are dealt with through the implementation of an exhaust port 26 exhibiting a passageway 58 shape having a specific profile.

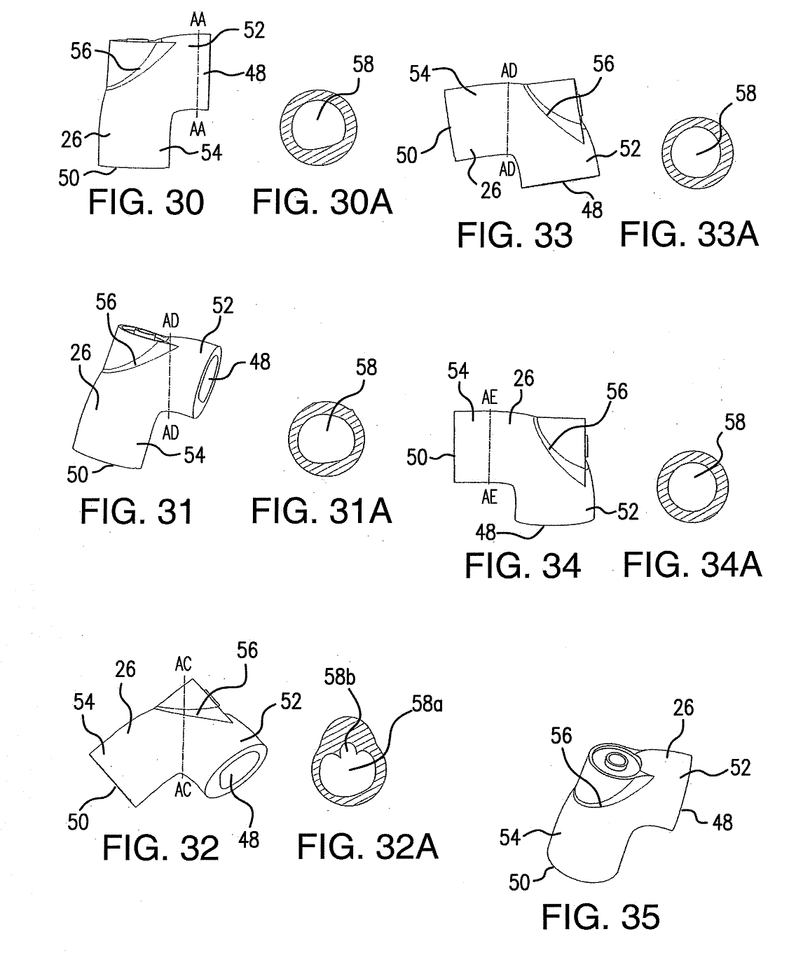

The inlet end 48 of the exhaust port 26 is shown in FIGS. 30 and 30A, and the progressive cross sectional views of the passageway 58 of the exhaust port 26 as it extends to the outlet of the exhaust port 26 are shown in FIGS. 31, 31A, 32, 32A, 33, 33A, 34 and 34A. With reference first to the inlet leg 52 of the exhaust port 26, the passageway 58 of the exhaust port 26 in the vicinity of the inlet end 48 to the exhaust port 26 has a substantially circular cross section as does the exhaust port 26 between the inlet end 48 of the exhaust port 26 and the exhaust elbow 56 of the exhaust port 26 (see FIGS. 30, 30A, 31 and 31A). Similarly, and with reference to the outlet leg 54 of the exhaust port 26, the passageway 58 of the exhaust port 26 in the vicinity of the outlet end 50 to the exhaust port 26 has a substantially circular cross section as does the passageway 58 of the exhaust port 26 between the outlet end 50 of the exhaust port 26 and the exhaust elbow 56 of the exhaust port 26 (see FIGS. 33, 33A, 34 and 34A).

However, and with reference to FIGS. 32 and 32A, the exhaust port 26 in the vicinity of the exhaust elbow 56 has a passageway 58 profile composed of a large diameter first passageway 58a, which is ultimately an extension of passageways extending from inlet end 48 and the outlet end 50, and a small diameter second passageway 58b, which also functions as a passageway for the exhaust valve stem 80 and associated valve guide tube 84. The large diameter first passageway 58a and the small diameter second passageway 58b intersect to define the complete passageway profile in the vicinity of the exhaust elbow 56.

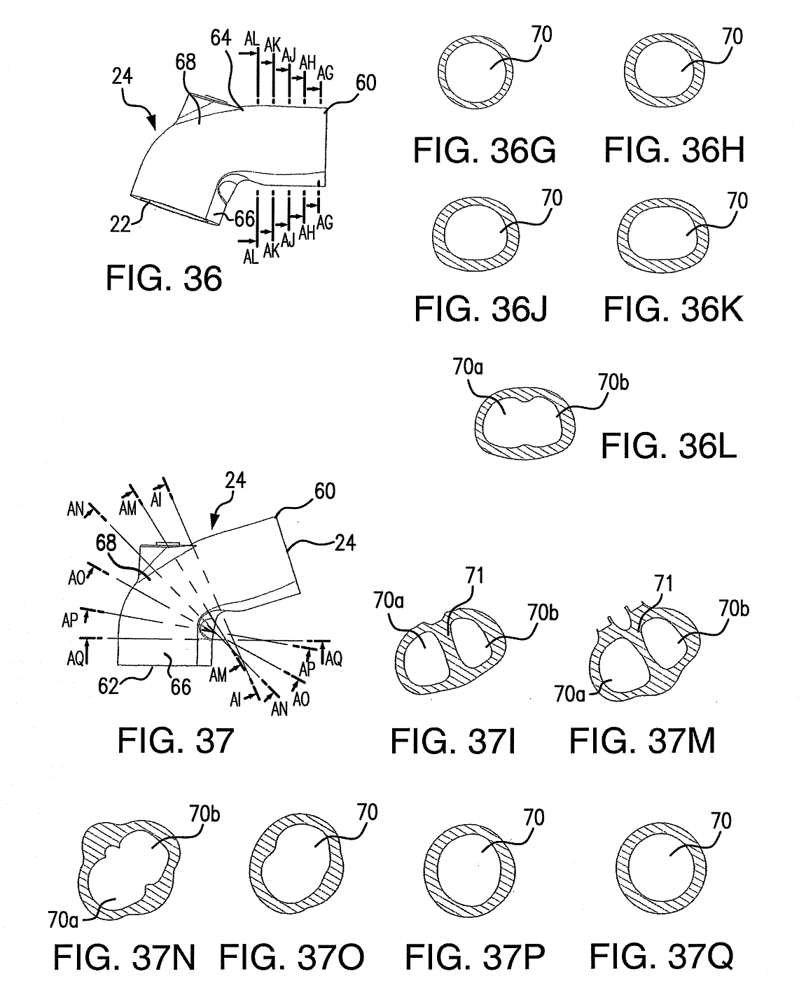

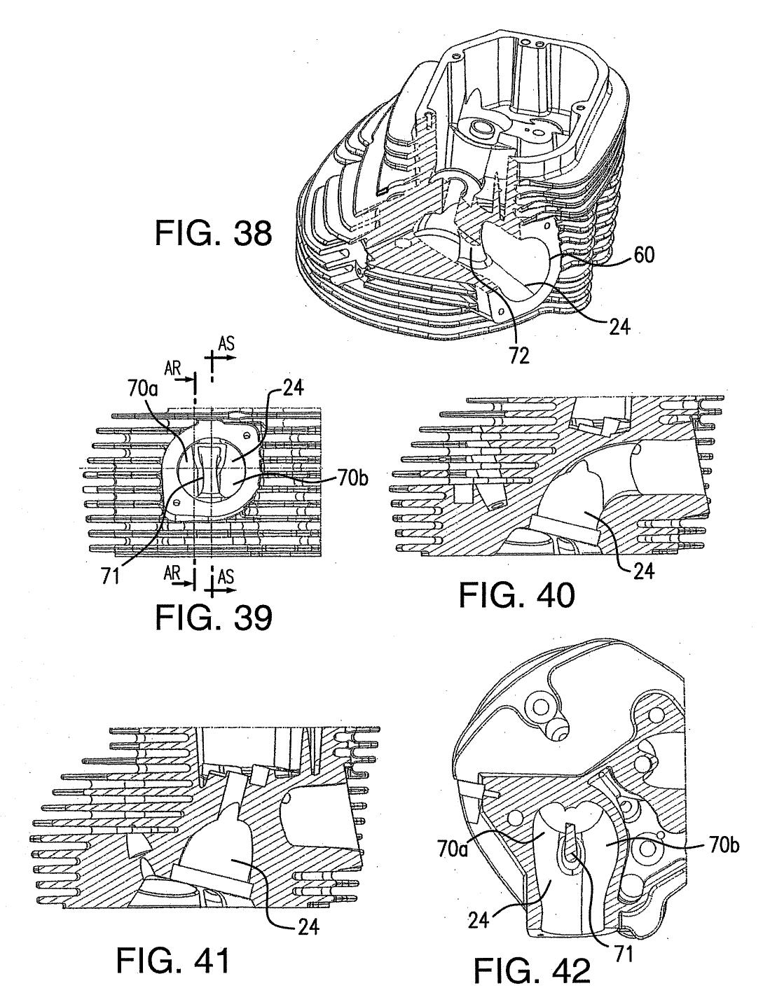

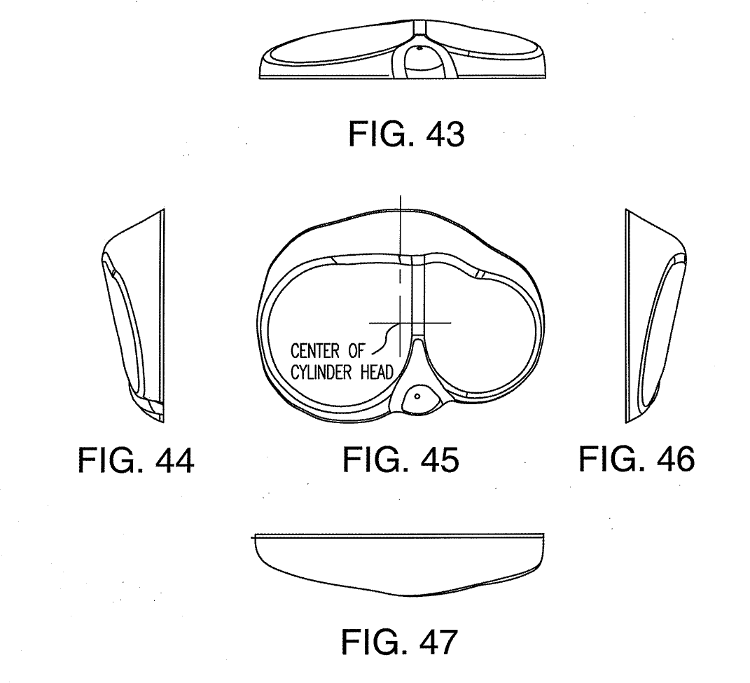

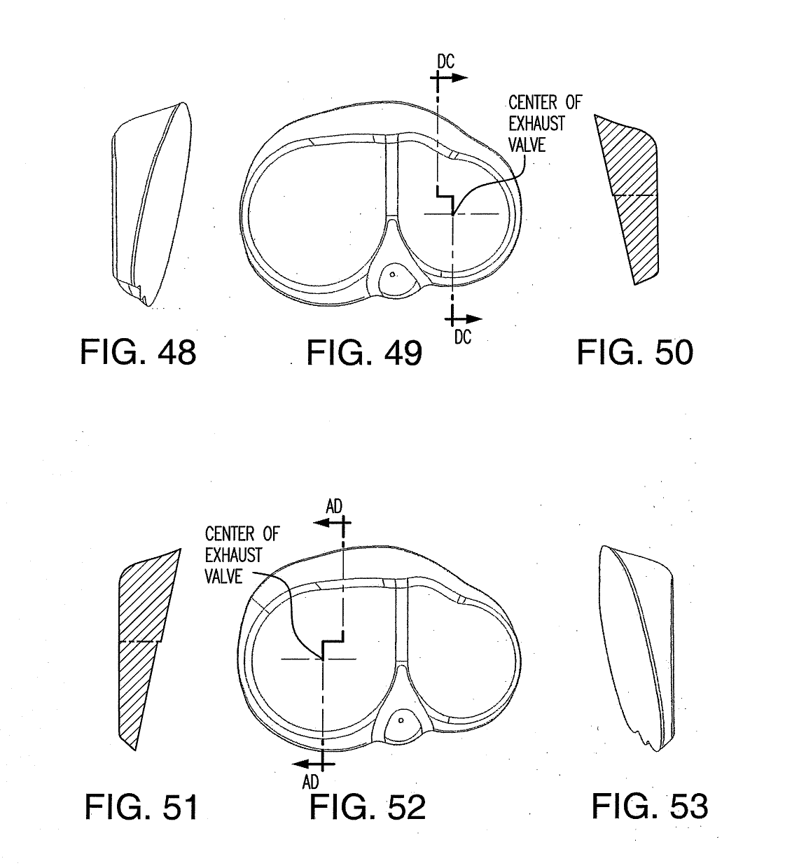

Referring now to the intake port 24, as shown with reference to FIGS. 36 to 42, the intake port 24 exhibits a generally L-shaped configuration (although not 90 degree as discussed below in greater detail) as its extends from the inlet end 60 of the intake port 24 to the outlet end 62 of intake port 24. As such, the intake port 24 may be thought of as including an inlet leg 64, an outlet leg 66 and an inlet elbow 68 therebetween. This L-shape results in approximately a 70 degree turn, which it is appreciated generates flow issues that are dealt with through the implementation of an intake port 24 exhibiting a passageway shape having a specific profile.

The inlet end 60 to the intake port 24 is shown in FIGS. 36, 36G, 36H, 36J, 36K and 36L with progressive cross sectional view of the passageway 70 of the intake port 24 as it extends to the outlet end 62 of the intake port 24. As the Figures show, and with reference to the inlet leg 64 of the intake port 24, the passageway 70 of the intake port 24 in the vicinity of the inlet end 60 to the intake port 24 has a substantially circular cross section. This cross sectional passageway profile is maintained as the intake port 24 extends from the inlet end 60 toward the inlet elbow 68 (see FIGS. 36G, 36H, 36J and 36K). However, as the intake port 24 approaches the inlet elbow 68, the passageway 70 of the exhaust port 26 bifurcates into adjacent substantially oval passageways 70a, 70b (see FIGS. 36I, 36M and 36N) with a separating wall 71 therebetween. As the intake port 24 extends from the inlet elbow 68 to the outlet end 62 of the intake port 24, the oval passageways 70a, 70b merge together to once again form a substantially circular passageway 70 at the outlet end 62 that is ultimately similar to the passageway profile exhibited at the inlet end 60 of the intake port 24 (see FIGS. 36O, 36P and 36Q). The bifurcation of the passageway 70 into oval passageways 70a, 70b with a separating wall 71 therebetween creates “swish and swirl” as air enters the intake port 24 and passes to the combustion chamber. This swish and swirl optimizes the fuel mixing within the combustion chamber.

The distinctive shapes of the passageways 58, 70 of the intake port 24 and the exhaust port 26 are achieved by first building mold member replicating the intake port 24 and the exhaust port 26. The cylinder head 10 is then cast about the mold members allowing for the incorporation of highly distinct inlet and exhaust ports without the need for machining inlet and exhaust ports after casting of the cylinder head. The mold members are then removed leaving the cylinder head with the passageways described herein.

The cylinder head 10 is further provided with an intake valve assembly 28 and an exhaust valve assembly 30. The intake valve assembly 28 includes a longitudinal axis which is oriented at approximately a 15 degree angle relative to a transverse axis extending perpendicular to the plane in which the base of the cylinder head 10 lies. Similarly, the exhaust valve assembly 30 includes a longitudinal axis which is oriented at approximately a 15 degree angle relative to a transverse axis extending perpendicular to the plane in which the base of the cylinder head lies.

The intake valve assembly 28 includes an inlet valve stem 72 with an intake valve 74 capable of opening and closing the intake valve bore 44. The inlet valve stem 72 of the intake valve assembly 28 is slidably received in a guide tube 76 mounted in the cylinder head 10, and a valve spring 78 is provided for biasing the intake valve 74 upwards, i.e., in a valve closing direction are mounted between the cylinder head 10 and retainer mounted at upper ends of the inlet valve stem 72 protruding upwards from the guide tube 76.

The exhaust valve assembly 30 includes an exhaust valve stem 80 with an exhaust valve 82 capable of opening and closing the exhaust valve bore 46. The exhaust valve stem 80 of the exhaust valve assembly 30 is slidably received in a guide tube 84 mounted in the cylinder head 10, and a valve spring 86 is provided for biasing the exhaust valve 82 upwards, i.e., in a valve closing direction are mounted between the cylinder head 10 and retainer mounted at upper end of the exhaust valve stem 80 protruding upwards from the guide tube 84.

The intake valve 74 is opened and closed by an intake-side valve operating device 88, and the exhaust valve 82 is opened and closed by an exhaust-side valve operating device 90.

The intake-side valve operating device 88 includes a driving rocker arm 96 with a rocker shaft 106 corresponding to the intake valve assembly 28 and the exhaust-side valve operating device 90 includes a driving rocker arm 98 with a rocker shaft 108 corresponding to the exhaust valve assembly 30. The rocker arms are operated in a conventional manner well known to those skilled in the art.

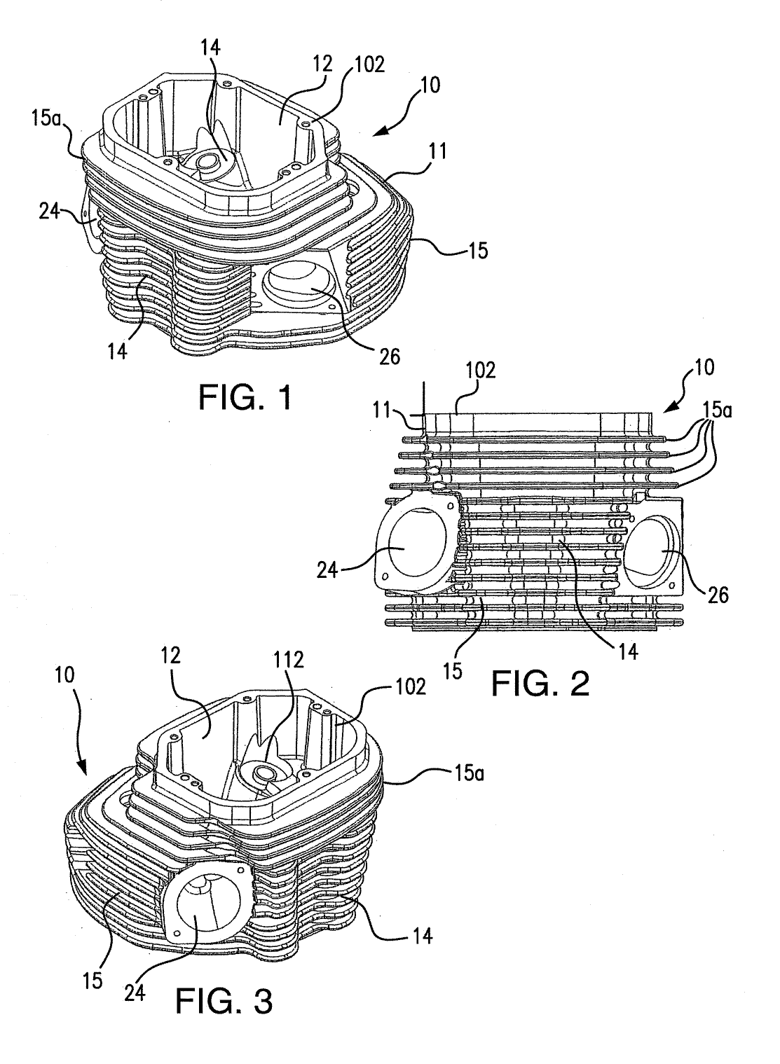

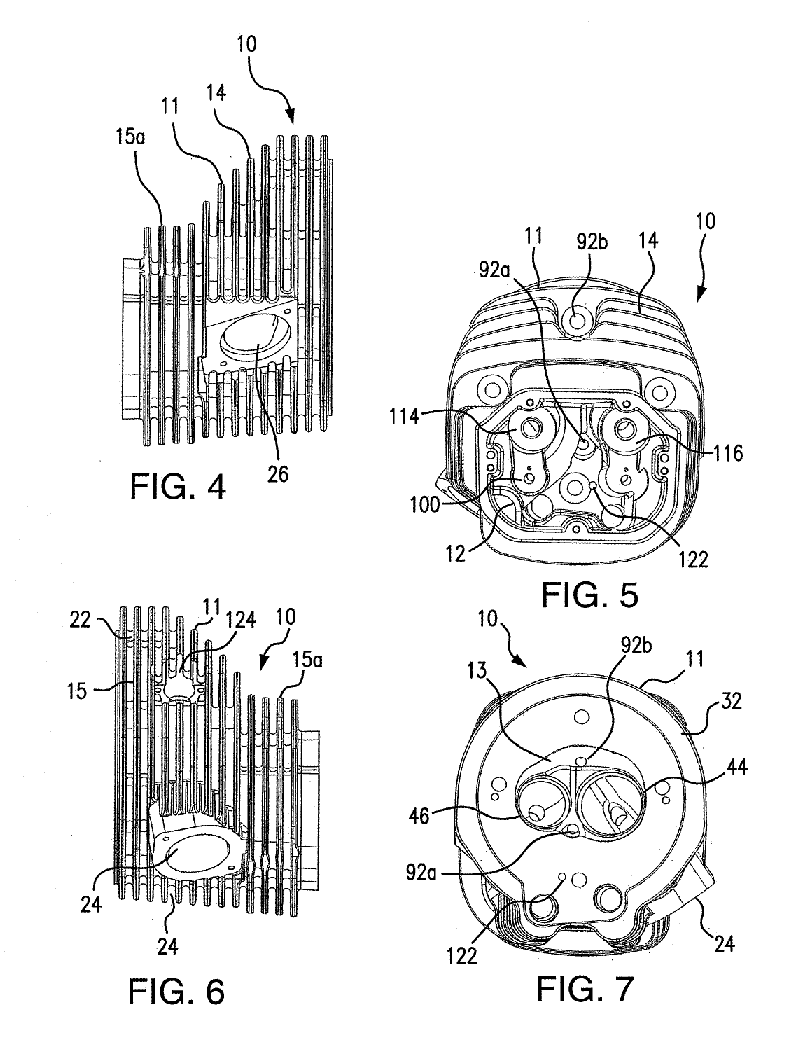

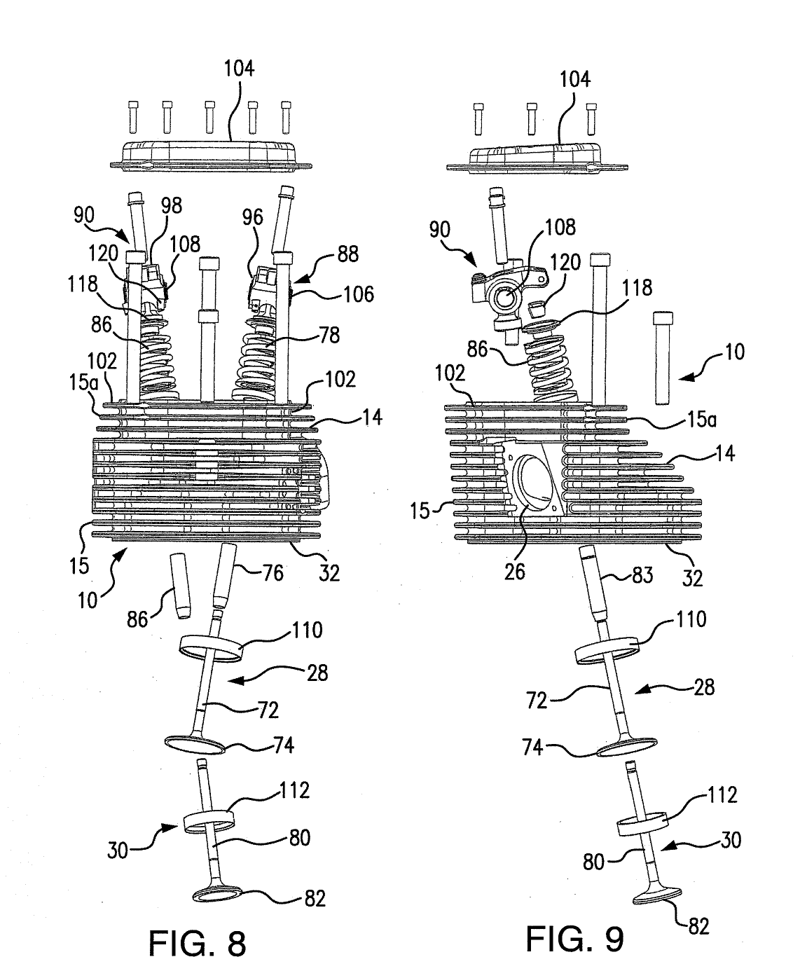

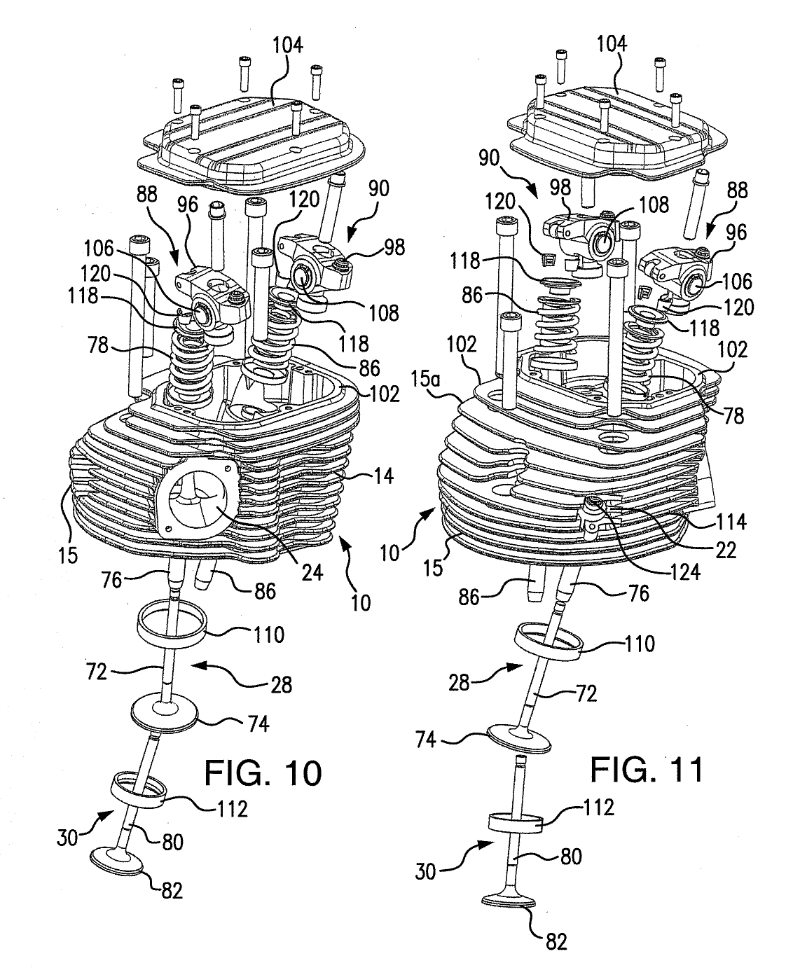

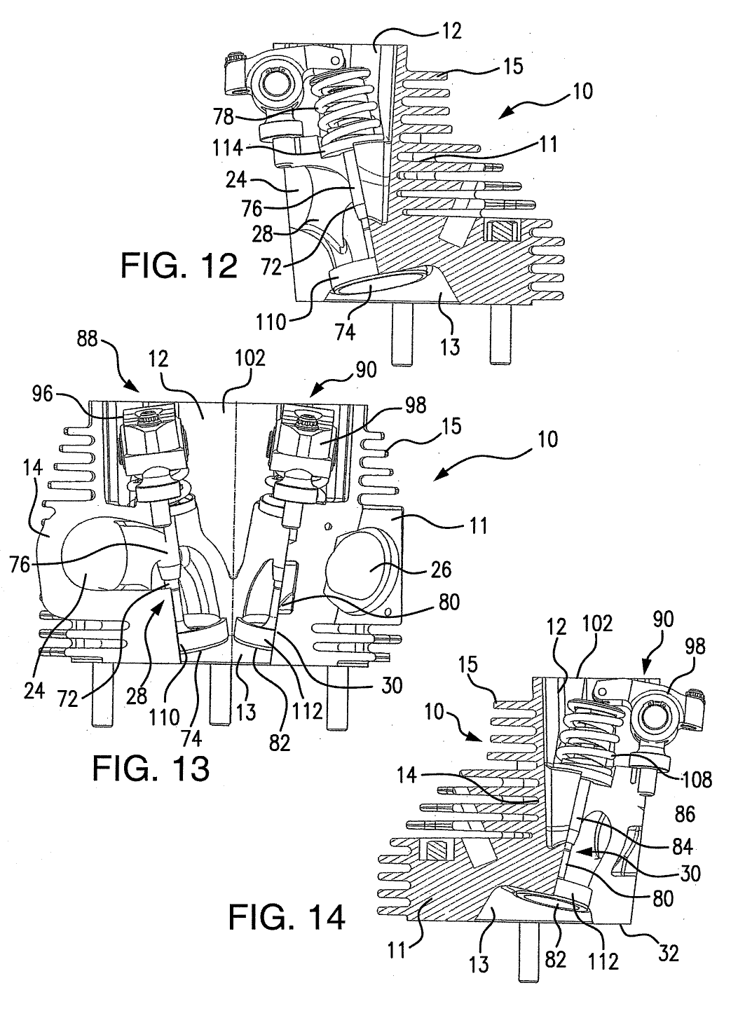

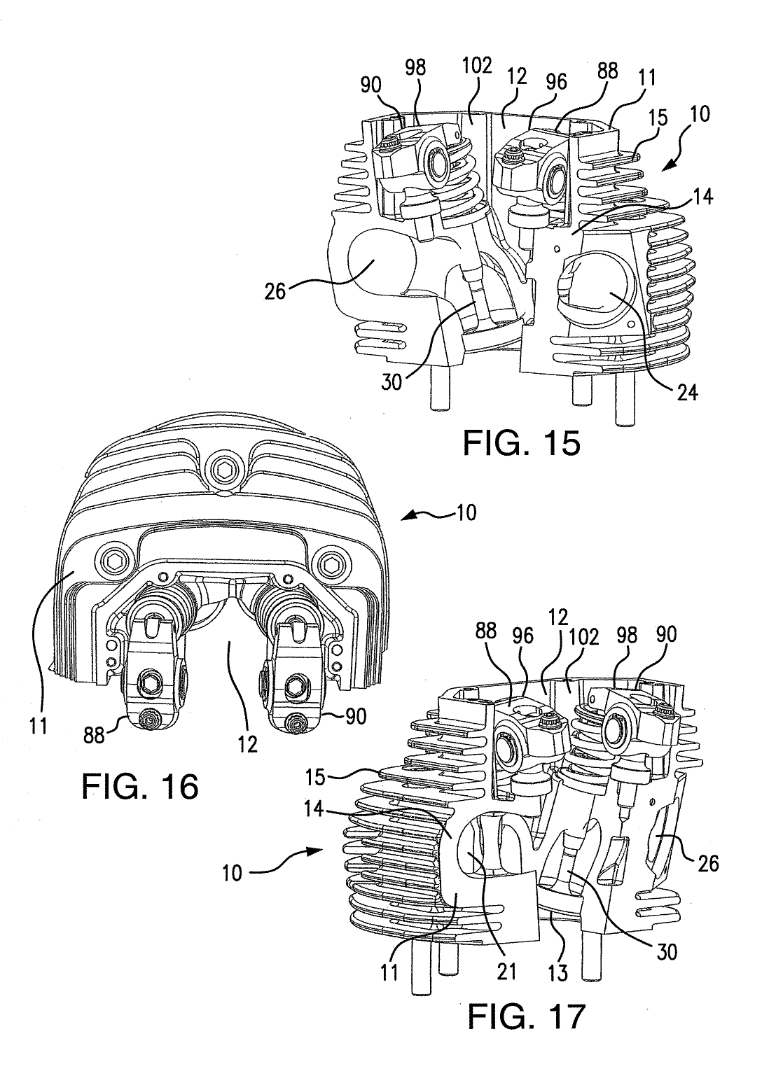

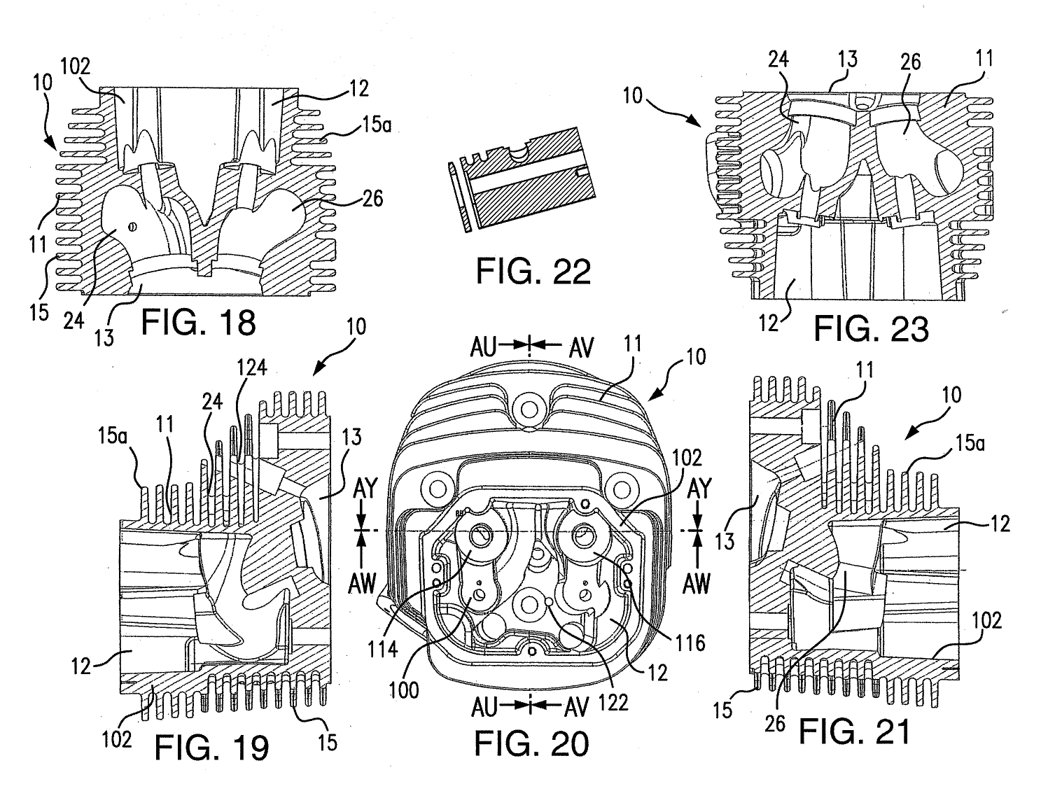

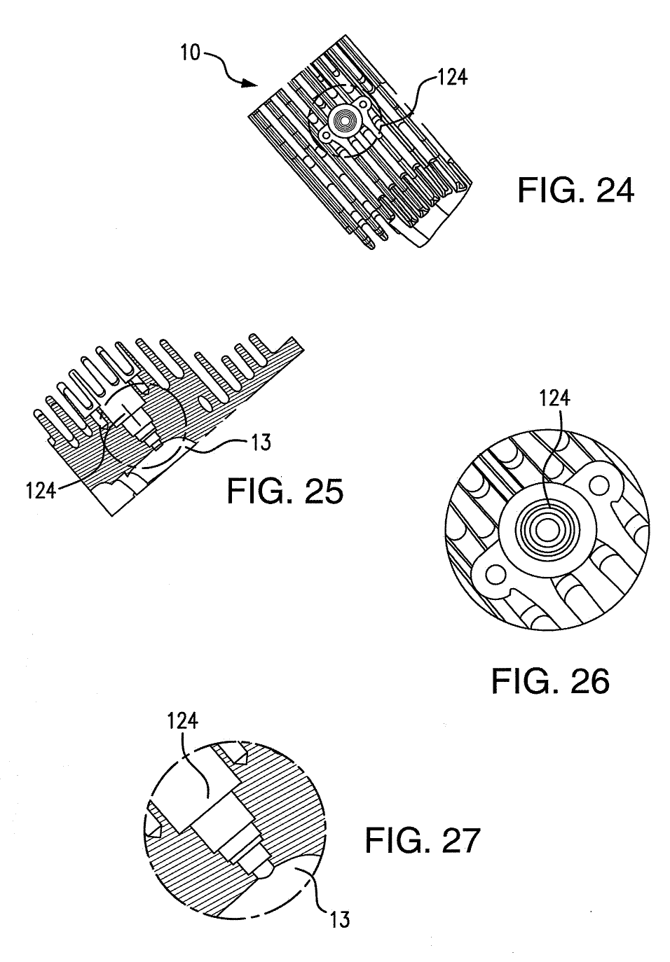

The intake-side and exhaust-side rocker shafts 106 and 108 are fixedly supported by machined supporting members 100 provided on the cylinder head 10 within the upper cavity 12. In particular, the present cylinder head 10 is integrally formed with the rocker box 102 to which the rocker arms 96, 98 are pivotally mounted. The rocker box 102 is covered with a rocker cover 104 secured thereto with screws. As such, and as shown with reference to FIGS. 1 to 3, heat exchange fins 15 are formed along the outer surface of the cylinder head 10, including fins 15a along the rocker box 102 formed integrally therewith. In addition, the tubes for the push rods (not shown) of the intake-side valve operating device 88 and the exhaust-side valve operating device 90 are integrally formed within the side walls 14 of the cylinder body 11.

The cylinder head 10 is further provided with a recess 124 for mounting a fuel injection cartridge for the supply of fuel to the combustion chamber. The recess 124 is provided in the side wall 14 of the cylinder head body 11 providing for ready access to the combustion chamber. In particular, the fuel injector recess 124 positions the fuel injector directly beneath the valves, and straight into the cylinder head 10, for optimized combustion. The upper cavity 12 of the cylinder head body 11 is further provided with an oil drainage opening 122 allowing for convenient drainage and supply of oil to the upper cavity 12 for lubrication of the parts therein.

The cylinder head 10 further includes first and second plug insertion holes 92a, 92b shaped and dimensioned for the mounting of a pair of spark plugs 94a, 94b mounted in the cylinder head 10 to face the central portion of the combustion chamber.

The cylinder head 10 is assembled in the following manner. The intake valve seat 110 and the exhaust valve seat 112 are respectively inserted into machined pockets, that is, the intake valve bore 44 and the exhaust valve bore 46, within the cylinder head 10, and the intake valve stem 72 and exhaust valve stem 80 slide up valve guide tubes 76, 84. Valve springs 78, 80 sit upon spring seats 4 which, in turn, locate in machined pockets 114, 116 in cylinder head 10. The springs 78, 80 are compressed, and valve retainers 118 and valve clips 120 are positioned around intake valve stem 72 and the exhaust valve stem 80, after which springs 78, 80 are relaxed, thus forcing the intake valve 74 and the exhaust valve 82 upward to seat against intake and exhaust valve seats 110, 112, forming an airtight seal. All of the parts are assembled coaxially about the axis of each valve stem. The rockers 96, 98 are then located and fastened in position upon machined supporting members 100 within rocker box 102 of the cylinder head 10. The entire assembly thus far is then positioned and fastened in place upon one of the piston barrels (not detailed) using dowels and fasteners, after which rocker cover 104 can be positioned and fastened to cylinder 10 using dowels and fasteners.

It will be appreciated by those of ordinary skill in the art that with the benefit of this disclosure, many variations can be made to the invention exemplified above without departing from the broad ambit and scope of the invention. Accordingly, it is the claims set forth below that are intended to define the exclusive rights of the invention.

As a result of the shape and contours of the surfaces of the intake port, exhaust port and the combustion chamber, along with the arrangement of the associated parts within the assembly of the cylinder head, including the general design of the cylinder head itself, a high degree of efficiency is achieved in the fuel consumption and that the power output is greatly increased.

While the preferred embodiments have been shown and described, it will be understood that there is no intent to limit the invention by such disclosure, but rather, is intended to cover all modifications and alternate constructions falling within the spirit and scope of the invention.

1. A cylinder head for an internal combustion engine, the cylinder head being shaped and dimensioned to sit above a cylinder on top of a cylinder block so as to define a combustion chamber, the cylinder head comprising:
a cylinder head body including a lower cavity defining a portion of a combustion chamber when the cylinder head is secured to a cylinder block;
the cylinder head body also includes an intake port and an exhaust port in fluid communication with the lower cavity, wherein the exhaust port has a generally L-shaped configuration as its extends from an inlet end of the exhaust port to an outlet end of the exhaust port, and the intake port has a generally L-shaped configuration as its extends from an inlet end of the intake port to an outlet end of intake port;
wherein the intake port includes an inlet leg, an outlet leg and an inlet elbow therebetween, and as the intake port approaches the inlet elbow, a passageway of the exhaust port bifurcates into adjacent substantially oval passageways.
